(19) United States
(12) Patent Application Publication
(10) Pub. No.: US 2007/0286015 A1
(43) Pub. Date: Dec. 13, 2007

(54) Magnetic mixer drive system and method

(75) Inventor: Stephen L. Markle, Holley, NY (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX CORPORATION

(21) Appl. No.: 11/448,659

(22) Filed: Jun. 8, 2006

(51) Int. Cl. B01F 13/08

(52) U.S. Cl. 366/273

(57) ABSTRACT

An improved magnetic drive for a mixing system and method, wherein stagnation or collection of material in the region of the containment shell and any magnetic rotor are alleviated by the provision of pitched blades provided as radially extending spokes in the inner magnetic rotor. This bladed rotor design may be particularly advantageous in the case of a side entry mixer.

### FIELD OF THE INVENTION

The present invention relates generally to the field of mixers, mixing devices and mixing methods and, more particularly, relates to the field of mixers wherein a rotating shaft supports a rotating impeller inside a vessel, and the shaft is magnetically driven.

### BACKGROUND OF THE INVENTION

Mixers and mixing devices are in wide use in industry. One type of mixing device mixes a material inside of a vessel by virtue of a shaft that projects into the vessel and is rotated by a drive system. The shaft supports radially extending impellers, which rotate with the shaft and agitate, mix, and otherwise impart energy to the material in the vessel.

Usually the drive system, which includes a motor and a gear box, is located outside of the vessel. Thus, the mixing impeller shaft, which is disposed inside the vessel, needs to be driven by this drive system, which is outside of the vessel. In one arrangement, the shaft penetrates an aperture of the vessel and is supported by some type of bearing and seal arrangement. However, in situations where high sanitary and/or cleanability conditions are required, the system using bearings and seals may not be the most suitable system. That is, these systems can be difficult to clean and/or the bearing and seal regions may tend to collect undesirable materials.

In response to the above situation, a type of mixer has been developed which is a so-called magnetically driven mixer. In such mixers, the vessel has an aperture, and a containment shell or canister is mounted around the aperture to close off the aperture. On the inside of the vessel, inside of the containment shell, a bearing support system is provided for the impeller shaft and the impellers. Also, inside of the canister, at the end of the impeller shaft, is located a rotor that has magnets mounted to or included as part of the rotor. Outside of the containment shell and outside of the vessel is mounted a drive system, typically including a motor and gear reducer, which drives the drive shaft that has an outer magnetic rotor.

The outer magnetic rotor includes a ring that surrounds the containment shell, with the ring being rotated by the drive system so that it produces a rotating magnetic field, which interacts with the magnets in the inner magnetic rotor, so the rotation of the outer magnetic rotor causes rotation of the inner magnetic rotor. These magnetic drive systems are advantageous in many applications where it is desired to have high sanitary conditions or high cleanability. One advantage of these systems is that the interior of the vessel can be completely sealed includes the area of the drive system.

These magnetic drive systems using a canister have been found particularly effective in the case of so called “top entry” mixers. That is, in the case of top entry mixers where the magnetic drive system is located in the top of the vessel, the area inside the canister typically does not tend to encounter any undesirable sedimentation or lack of circulation of material in this area.

Another type of magnetic mixer is the so-called “side entry” mixer. In a side entry mixer, the impeller shaft is generally horizontal, and is projecting into the vessel along a vertical sidewall thereof. Side entry mixers can be advantageous for a variety of applications. However, one disadvantage of some side entry mixers in some applications is that the canister can provide a sort of “dead zone” where a lack of circulation of the fluid or other material being mixed occurred. This lack of circulation may also be referred to as stagnation.

In some applications, such a lack of circulation or dead zone is disadvantageous, particularly in the case of very long cycle times between cleanings, for example, if the material is biological or bioactive, food or cosmetic related, or otherwise susceptible to spoilage or degredation, the stagnation can lead to problems with the product. For example, in the case of food products, it may be undesirable to have a stagnant area inside the canister region because spoilage or similar degradation of the food product could occur. Also, sedimentation can occur in the region of the canister or containment shell.

Accordingly, it would be desirable to have a magnetic drive mixer in which the above noted problems are overcome to at least some extent, and in which stagnant areas inside the containment shell of the magnetic drive mixer can be reduced or mitigated at least to some extent.

### SUMMARY OF THE INVENTION

Accordingly, it would be desirable to have a magnetic drive mixer in which the above noted problems are overcome to at least some extent, and in which stagnant areas inside the containment shell of the magnetic drive mixer can be reduced or mitigated at least to some extent.

In accordance with another embodiment of the present invention, a drive apparatus for a mixing device that mixes material in a vessel having an entry opening, the drive apparatus has a containment shell that encloses the entry opening; a driven outer magnetic rotor disposed outside of the containment shell; and an inner magnetic rotor disposed inside the containment shell, wherein the inner magnetic rotor has one or more pitched blades.

In accordance with yet another embodiment of the present invention, a drive apparatus for a mixing device that mixes material in a vessel having an entry opening, the drive apparatus has a containment means for enclosing the entry opening; a driven outer magnetic rotor disposed outside of the containment shell; and an inner magnetic rotor disposed inside the containment means, wherein the inner magnetic rotor has means for circulating fluid in the containment means.

In accordance with yet another embodiment of the present invention, a method for mixing material in a vessel having an entry opening, the method includes enclosing the entry opening with a containment shell driving a driven outer magnetic rotor disposed outside of the containment shell or an impeller shaft using an inner magnetic rotor disposed inside the containment shell, wherein the inner magnetic rotor has one or more pitched blades.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view taken through line 1-1 in FIG. 2, in which FIG. 1 illustrates a side entry magnetic impeller shaft drive system according to a preferred embodiment of the present invention.

FIG. 2 is an end view of the side entry magnetic impeller shaft drive system of FIG. 1.

FIG. 3 is a perspective view of a mounting flange used in the side entry magnetic drive system of FIG. 1.

FIG. 4 is perspective view of an inner magnetic rotor used in the side entry magnetic drive system of FIG. 1.

### DETAILED DESCRIPTION

Some preferred embodiments provide a method and apparatus for magnetic mixing that avoids stagnation in the area inside the canister or containment shell and in the area of the inner magnetic motor. The references to canister and containment shell herein refer to like parts. Some preferred embodiments of the invention will now be described with reference to the drawing figures, in which like reference numerals refer to like components throughout.

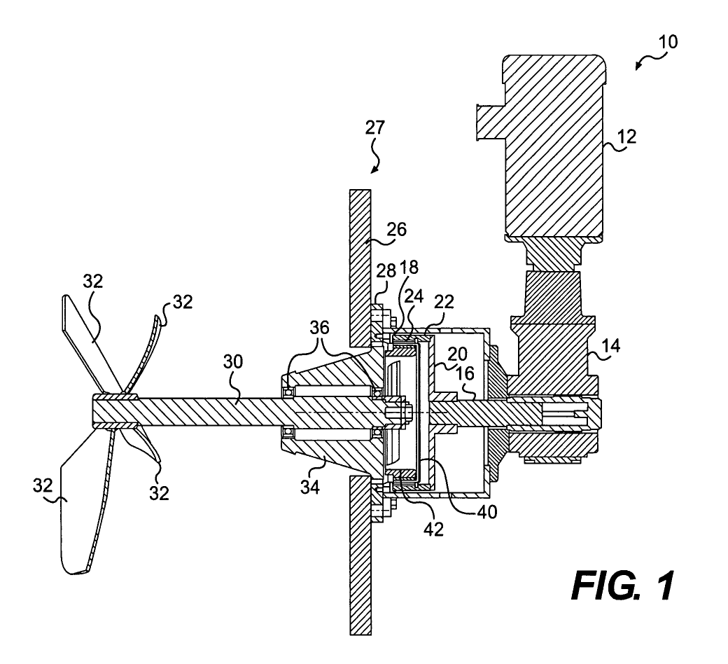

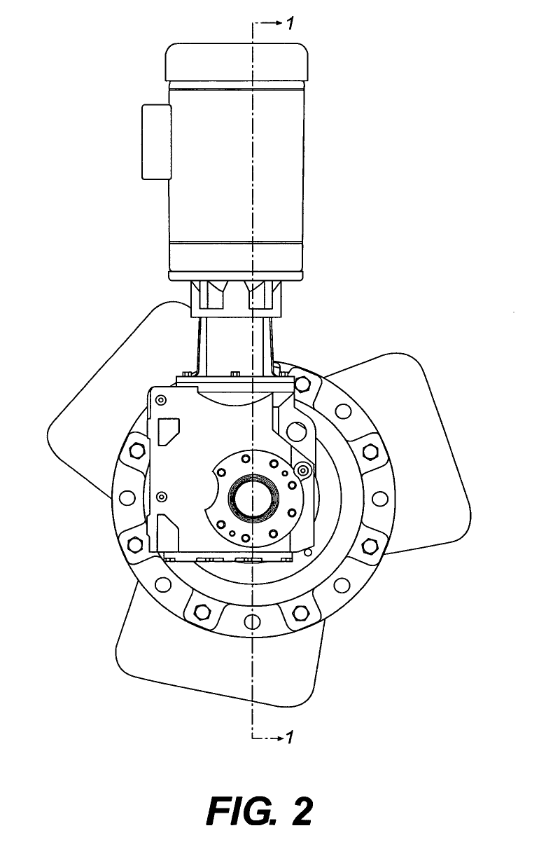

FIG. 1 is a cross-sectional view of a magnetic impeller drive system 10 according to one preferred embodiment of the present invention. The system 10 includes a motor 12, which is typically an electrically driven motor, that is connected to a gear box system 14, which typically includes a gear reducer having a predetermined ratio.

The gear box 14 drives a drive shaft 16 which is connected to an outer magnetic rotor 18. The outer magnetic rotor 18 can include a radial disc 20 which is connected to a ring-shaped outer magnetic rotor ring 22 which supports outer magnets 24. The inward facing outer magnets 24 are typically located on the inside face of the outer rotor 22. The outer magnets 24 are usually a plurality of evenly circumferentially spaced individual magnet elements and they be attached to the inside of the outer magnet rotor 22 by being bonded, glued, or otherwise retained.

The assembly including the motor 12, gear box 14, shaft 16, and rotor 18 is mounted to the wall 26 of the vessel 27 containing the material to be mixed, and may be directly mounted to the vessel wall 26 or be mounted through attachment to an impeller shaft mounting flange 28 which will be discussed in more detail below.

The system 10 further includes a rotating impeller shaft 30 which supports a plurality of radially extending impeller blades 32 inside the vessel in order to agitate or otherwise impart energy to the material inside the vessel which is to be mixed or otherwise treated.

The impeller shaft 30 is supported by the mounting flange 28 which is mounted in an aperture of the vessel wall 26. The mounting flange 28 may support some form of bearing arrangement for rotationally supporting the impeller shaft 30. In the illustrated preferred embodiment, a pair of ball bearing assemblies 36 are provided, including an extension 34 of the mounting flange 28, as shown to support the impeller shaft 30. Of course, other types of bearings could be used.

In the illustrated embodiment, the ball bearings 36 may be of an all ceramic, or partially ceramic type, which may be desirable since the material to be mixed is in contact with the bearings 36. Such partially or all ceramic bearings 36, or other suitable wet running bearings, are advantageous in certain applications, since they do not require lubrication.

A containment shell 40, also referred to as a canister, is mounted to the mounting flange 28 so that it provides an enclosure wherein fluid cannot escape the vessel 27. In the preferred embodiment, the flange 28 is mounted to the vessel wall 26, and the containment shell 40 and drive housing are each mounted to the mounting flange 28.

At the driven end of the impeller shaft 30 is mounted an inner magnetic rotor 42, which is illustrated in greater detail in FIG. 4. Referring to both FIGS. 1 and 4, the inner magnetic rotor 42 includes an inner hub 44 which is attached to the impeller shaft 30, and a plurality of angled pitched blades 46 that extend radially outward to an inner magnetic ring 48. The inner magnetic ring 48 includes an inner magnetic arrangement 50, which may be a plurality of individual circumferentially spaced outward facing magnets mounted to the radially outward face of the ring 48. The magnets also may be mounted by being bounded, glued, or otherwise attached.

As can be seen in FIG. 1, the inner magnetic ring 48 of the inner magnetic rotor 42 is sized to have a relatively close clearance gap with the inside of the containment shell 40, and the outer magnetic rotor 18 is sized to have a relatively close clearance with the containment shell 40, so that a magnetic field can pass through the containment shell 40 and so that rotation of the outer magnetic rotor 18 causes rotation of the inner magnetic rotor 42 to provide a magnetic drive while still having a complete containment of material in the tank provided by the containment shell 40.

A benefit of the pitched blades 46, compared to a solid rotor, is that material that would otherwise tend to collect or stagnate in the area of the rotor inside the containment shell 40 is instead pumped or driven by the pitched blades 46. This pumping action provided by the pitched blades 46 facilitates agitation of the material inside this region and also can facilitate circulation of material into and out of the region, and can also alleviate sedimentation in this area.

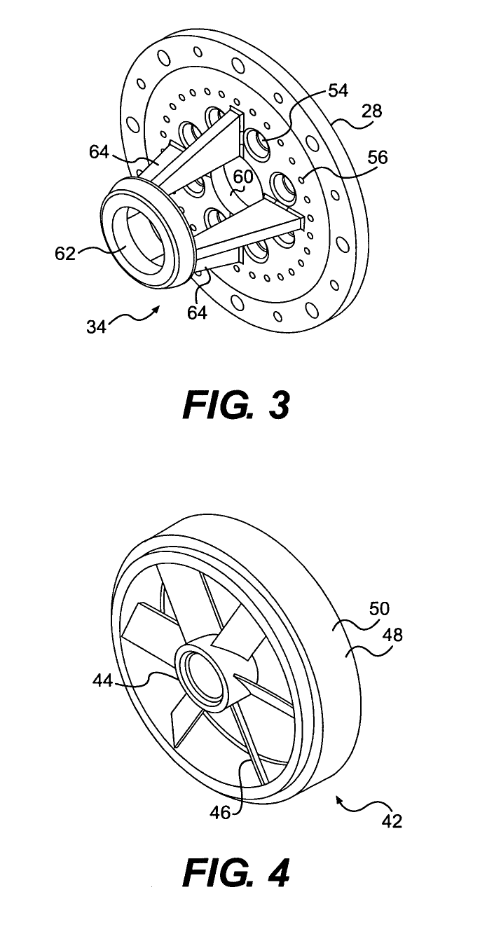

The pumping and circulation feature can be enhanced by the provision of apertures which may be provided by the mounting flange 28 as illustrated in FIG. 3. In particular, the embodiment of FIG. 3 includes a plurality of large apertures 54 generally disposed in a circular fashion around the mounting flange 28, and also a plurality of smaller apertures 56 disposed in another circle around the mounting flange 28 at a somewhat radially outward location thereof, compared to the large apertures 54.

Rotation of the inner magnetic rotor 42 including the pitched blades 46 generates pressure differences within the containment shell region, and thus the tank contents tend to be drawn in through the large holes 54 of the mounting flange 28 tend to flow around inside the containment shell and inner rotor region, and the tank contents will thus tend to be forced to turn back into the main tank area through the smaller holes 56. This provides an improvement, compared to an inner magnetic rotor in the form of a solid disc, because the pumping action of this embodiment avoids or at least can reduce stagnation in some cases.

It will also be appreciated that the extension 34 of the mounting flange 28 provides a first bearing support area 60 as well as a second bearing support area 62. The extension 34 includes a plurality of support arms 64. The provision of individual support arms 64 facilitates the flow of material to the bearings 36 and the drive shaft 30 area, as compared to a sleeve bearing. Thus, in this embodiment, further flow of material is facilitated due to the extension 34 and the spacing apart of the support arms 64.

While the example of a preferred embodiment illustrated in FIG. 4 has an inner magnetic rotor having flat or relatively flat pitched blades 46, it will be appreciated that other blade shapes or geometries may be utilized as desired.

From the foregoing, it will be appreciated that some preferred embodiments of the invention provide an improved magnetic mixing system and method, wherein stagnation or collection of material in the region of the containment shell and the magnetic rotor are alleviated by the provision of pitched blades provided as radially extending spokes in the inner magnetic rotor.

This bladed rotor design may be particularly advantageous in the case, by way of example, of a side entry mixer as illustrated in FIG. 1. It will be appreciated that this design may also be beneficial regardless of the orientation of the impeller shaft and containment shell, and so various embodiments may be also suitable for top entry or even bottom entry mixers.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A drive apparatus for a mixing device that mixes material in a vessel having an entry opening, the drive apparatus comprising:
a containment shell that encloses the entry opening;
a driven outer magnetic rotor disposed outside of the containment shell; and
an inner magnetic rotor disposed inside the containment shell, wherein the inner magnetic rotor has one or more pitched blades.

2. The apparatus of claim 1, wherein the inner magnetic rotor has an inner hub attached to an impeller shaft.

3. The apparatus of claim 2, further comprising a plurality of impeller blades attached to the impeller shaft.

4. The apparatus of claim 3, further comprising a mounting flange that supports the impeller shaft via one or more bearings.

5. The apparatus of claim 4, wherein the mounting flange includes a plurality of first holes therethrough and a plurality of second holes therethrough, wherein the first holes are larger than the second holes, and wherein fluid flows into and out of the containment shell through the first and second holes.

6. The apparatus of claim 1, wherein the axis of rotation of the inner magnetic rotor and the outer magnetic rotor is a substantially horizontal axis.

7. The apparatus of claim 6, wherein the mounting flange comprises two bearing support regions with two or more support arms extending between the first bearing support region and the second bearing support region.

8. A drive apparatus for a mixing device that mixes material in a vessel having an entry opening, the drive apparatus comprising:
a containment means for enclosing the entry opening;
a driven outer magnetic rotor disposed outside of the containment shell; and
an inner magnetic rotor disposed inside the containment means, wherein the inner magnetic rotor has means for circulating fluid in the containment means.

9. The apparatus of claim 8, wherein the inner magnetic rotor has an inner hub attached to an impeller shaft.

10. The apparatus of claim 9, further comprising a plurality of impeller blades attached to the impeller shaft.

11. The apparatus of claim 10, further comprising a mounting flange that supports the impeller shaft via one or more bearings.

12. The apparatus of claim 11, wherein the mounting flange includes a plurality of first holes therethrough and a plurality of second holes therethrough, wherein the first holes are larger than the second holes, and wherein fluid flows into and out of the containment shell is through the first and second holes.

13. The apparatus of claim 8, wherein the axis of rotation of the inner magnetic rotor and the outer magnetic rotor is a substantially horizontal axis.

14. The apparatus of claim 13, wherein the mounting flange comprises two bearing support regions with two or more support arms extending between the first bearing support region and the second bearing support region.

15. A method for mixing material in a vessel having an entry opening, the method comprising:
enclosing the entry opening with a containment shell;
driving a driven outer magnetic rotor disposed outside of the containment shell to drive an impeller, shaft using an inner magnetic rotor disposed inside the containment shell, wherein the inner magnetic rotor has one or more pitched blades.

16. The method of claim 15, further comprising circulating the fluid in the containment shell using the pitched blades.

17. The method of claim 16, further comprising mixing the material using impeller blades attached to the impeller shaft.

18. The method of claim 17, further comprising providing a mounting flange that supports the impeller shaft via one or more bearings.

19. The method of claim 18, wherein the mounting flange includes a plurality of first holes therethrough and a plurality of second holes therethrough, wherein the first holes are larger than the second holes, and wherein fluid flows into and out of the containment shell is through the first and second holes.

20. The method of claim 19, wherein the axis of rotation of the inner magnetic rotor and the outer magnetic rotor is a substantially horizontal axis.

21. The method of claim 20, wherein the mounting flange comprises two bearing support regions with two or more support arms extending between the first bearing support region and the second bearing support region.
